(19) United States
(12) Patent Application Publication
(10) Pub. No.: US 2015/0360253 A1
(43) Pub. Date: Dec. 17, 2015

(54) THIN FILM PATTERNING METHOD AND THIN FILM PATTERNING APPARATUS

(71) Applicants: BOE TECHNOLOGY GROUP CO., LTD., Beijing (CN); ORDOS YUANSHENG OPTOELECTRONICS CO., LTD., Ordos (CN)

(72) Inventors: Yu Liu, Beijing (CN); Chonkyu Min, Beijing (CN); Kunpeng Zhang, Beijing (CN); Fengguo Wang, Beijing (CN); Nini Bai, Beijing (CN)

(21) Appl. No.: 14/527,565

(22) Filed: Oct. 29, 2014

(30) Foreign Application Priority Data
Jun. 13, 2014 (CN) 201410263852.X

(51) Int. Cl. B05B 15/04

(52) U.S. Cl. CPC B05B 15/045

(57) ABSTRACT

Disclosed herein is a thin film patterning method and a thin film patterning apparatus. The thin film patterning method comprises the steps of: disposing a mask above a substrate, wherein the mask is provided with hollow-out parts which are identical with preset deposition patterns; and covering the mask with a thin film, wherein the thin film at hollow-out parts of the mask is formed on the substrate, while the remaining area of the substrate shielded by the mask is free of the thin film, so that a patterned thin film is formed on the substrate. The thin film patterning method in the present disclosure can transfer directly patterns on the mask to the substrate through one-step deposition, omit the process steps of photolithography and etching, simplify the process flow to a large extent, and save the costs of the thin film patterning.

### RELATED APPLICATIONS

The present application claims the benefit of Chinese Patent Application No. 201410263852.X, filed on Jun. 13, 2014, the entire disclosure of which is incorporated herein by reference.

### FIELD

This disclosure relates to the field of liquid crystal display, in particular to a thin film patterning method and a thin film patterning apparatus.

### BACKGROUND

In the manufacture of TFT-LCDs (Thin Film Transistor Liquid Crystal Display), various thin film patterns are formed by performing deposition and etching several times on a substrate, while a photolithography process is necessarily required during each time the thin film patterning is carried out, with an end to transfer the patterns on a photomask to a thin film deposited on the substrate, so as to form patterns required by design. Among the specific steps, first is coating photoresist and transferring, by means of a photochemical reaction, the patterns to the photoresist, then etching off the unwanted parts of the thin film by an etching process, and finally removing the photoresist such that the required patterns are formed on the thin film.

FIG. 1 illustrates the conventional thin film patterning steps, including: in step S10, depositing a layer of thin film 02 on a substrate 01; in step S20, coating a layer of photoresist 03 on the deposited thin film 02; in step S30, disposing the substrate obtained in the step S20 in an exposure machine on which a photomask 04 with certain formed patterns is mounted, such that only a part of incident light is irradiated through the photomask 04 on the photoresist 03 while the area of the photoresist 03 shielded by the photomask 04 is not irradiated by light; in step S40, developing and cleaning the substrate after exposure to thereby form photoresist patterns which are identical with the patterns of the photomask 04; in step S50, using an etching machine to etch off the parts of the thin film which are not protected by the photoresist by a wet-etching process or a dry-etching process so as to form the thin film patterns; and in step S60, lifting off the photoresist over the thin film patterns.

Various equipments of thin film deposition and pattern construction are needed by the above-described thin film patterning process, often including: film coating equipment (such as a Plasma Enhanced Chemical Vapor Deposition equipment and a sputtering machine) used in the step S10, exposure machine used in the step S30, etching machine (such as a dry-etching machine and a wet-etching machine) used in the step S50, and the like. These equipments are extremely expensive, and the deposition and pattern construction of each layer requires different equipment, therefore, the manufacturing equipments for thin film patterning in prior art are highly expensive in investment and manufacturing cost, and involve a long production cycle, a high risk of cross-contamination and a low yield.

### SUMMARY

It is an object of the present disclosure to simplify the thin film patterning process flow, reduce the manufacturing cost and improve the product yield.

In an exemplary embodiment of the present disclosure, a thin film patterning method is provided, which may comprise: disposing a mask above a substrate, wherein the mask is provided with hollow-out parts which are identical with preset deposition patterns; and covering the mask with a thin film, wherein the thin film at the hollow-out parts of the mask is formed on the substrate, while the remaining area of the substrate shielded by the mask is free of the thin film, so that a patterned thin film is formed on the substrate.

According to an exemplary embodiment, the method for manufacturing the mask may comprise: coating a hard material on a surface of a base substrate to form a hard material layer, and patterning the base substrate and the hard material layer according to the preset deposition patterns to form the hollow-out parts which are identical with the preset deposition patterns.

According to another exemplary embodiment, the base substrate may be of a stainless steel material.

According to another exemplary embodiment, the stainless steel material may be an SUS304 H stainless steel.

According to another exemplary embodiment, a thickness of the base substrate may be 0.03 mm, 0.05 mm, 0.06 mm, 0.08 mm or 1 mm.

According to a further exemplary embodiment, the hard material may be any of chromium, chromium oxide and iron oxide.

According to yet another exemplary embodiment, the thin film may be of a metal material or an organic material.

According to still another exemplary embodiment, the covering the mask with a thin film may be by means of a thin film deposition process.

In an exemplary embodiment of the present disclosure, a thin film patterning apparatus is also provided, which may comprise a mask and a film coating equipment, wherein the mask is provided with hollow-out parts which are identical with preset deposition patterns, and the film coating equipment forms a patterned thin film directly on a substrate by means of the mask.

According to an exemplary embodiment, the mask may comprise a base substrate and a hard material layer on a surface of the base substrate, wherein the base substrate and the hard material layer are provided with the hollow-out parts which are identical with the preset deposition patterns.

According to another exemplary embodiment, the base substrate may be of a stainless steel material.

According to another exemplary embodiment, the stainless steel material may be an SUS304 H stainless steel.

According to another exemplary embodiment, a thickness of the base substrate may be 0.03 mm, 0.05 mm, 0.06 mm, 0.08 mm or 1 mm.

According to a further exemplary embodiment, the hard material layer may be any of chromium, chromium oxide and iron oxide.

According to yet another exemplary embodiment, the thin film may be of a metal material or an organic material.

According to still another exemplary embodiment, the covering the mask with a thin film may be by means of a thin film deposition process.

Therefore, in the exemplary thin film patterning method, by substituting the prior art thin film patterning process, which comprises steps such as coating, exposure and etching, for using directly a mask with hollow-out patterns for thin film deposition on a substrate, the patterns on the mask are directly transferred to the substrate through one-step deposition, and thus the process steps of photolithography and etching are omitted, and the process flow is simplified to a large extent so that the thin film patterning no longer requires such expensive equipments as an exposure machine, an etching machine, etc., and the costs of the thin film patterning is saved. At the same time, the present disclosure provides a thin film patterning apparatus.

### BRIEF DESCRIPTION OF THE DRAWINGS

FIG. 1 is a schematic diagram of a thin film patterning process flow in the prior art;

FIG. 2 is a flow chart of steps of a thin film patterning method according to an exemplary embodiment;

FIG. 3 is a schematic diagram of disposing a mask above a substrate according to an exemplary embodiment;

FIG. 4 is a schematic diagram of thin film deposition according to an exemplary embodiment;

FIG. 5 is a schematic diagram of forming a patterned thin film on the substrate according to an exemplary embodiment;

FIG. 6 is a top view of a patterned mask according to an exemplary embodiment;

FIG. 7 is the patterned thin film obtained by using the mask in FIG. 6 for the manufacture of a thin film.

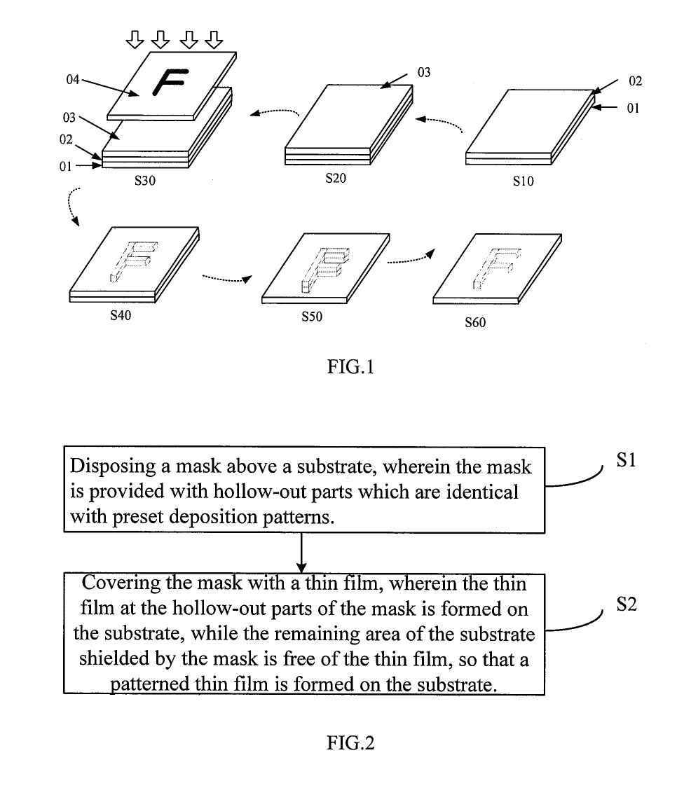

Wherein, the reference signs in respective figures represent:

01: substrate; 02: thin film; 03: photoresist; 04: photomask; 04′: mask.

### DETAILED DESCRIPTION

The present invention and associated general inventive concepts will be further described hereinafter in detail with reference to the accompanying drawings and various exemplary embodiments. One of ordinary skill in the art will appreciate that these exemplary embodiments only constitute a fraction of the possible embodiments encompassed by the present invention and the associated general inventive concepts. As such, the scope of the present disclosure is by no means limited to the exemplary embodiments set forth herein.

As shown in FIG. 2, a thin film patterning method may comprise the steps of: in step S1, disposing a mask above a substrate, wherein the mask is provided with hollow-out parts which are identical with preset deposition patterns; in step S2, covering the mask with a thin film, wherein the thin film at the hollow-out parts of the mask is formed on the substrate, while the remaining area of the substrate shielded by the mask is free of the thin film, so that a patterned thin film is formed on the substrate.

The thin film patterning method can transfer directly patterns on the mask to the substrate through one-step deposition, and thus omit the process steps of photoresist coating, photolithography and etching as in a prior art thin film manufacturing process, simplify the process flow to a large extent so that the thin film patterning no longer requires such expensive equipments as an exposure machine, an etching machine, etc., and the costs of the thin film patterning is saved.

The method for manufacturing the mask may comprise: coating a hard material on a surface of a base substrate to form a hard material layer, and patterning the base substrate and the hard material layer according to the preset deposition patterns to form the hollow-out parts which are identical with the preset deposition patterns.

It is to be noted that the base substrate used for manufacturing the mask may be of a stainless steel material. Due to the fact that the mask comprises the base substrate and the hard material layer on the surface of the base substrate, in consideration of the material choice of the base substrate thereof, generally an SUS304 H stainless steel with high tenacity is selected, with which the mask as manufactured is high in precision and bears smooth surface, which is also invulnerable to bending and deformation and is durable in use, and the mask is meanwhile enabled to fit tightly with devices so as to reduce the shadow effects. The thickness of the stainless steel base substrate may include various dimensions ranging from 0.03 mm, 0.0 5mm, 0.06 mm, 0.08 mm to 1 mm, among which a thinner stainless steel base substrate would result in a mask with less shadow effects and more controllable in disturbance.

Moreover, the mask further requires a considerably low coefficient of expansion so as to ensure that the dimensions of the mask and of the patterns on the mask could not be influenced by any temperature rise during the process of utilizing the mask for manufacture, or that such influence could be as reduced as possible.

The hard material may be any of chromium, chromium oxide and iron oxide.

By means of the steps S1-S2, the thin film is formed in areas of the substrate corresponding to the hollow-out parts of the mask, while the remaining area of the substrate shielded by the mask is free of the thin film, i.e. a patterned thin film is formed.

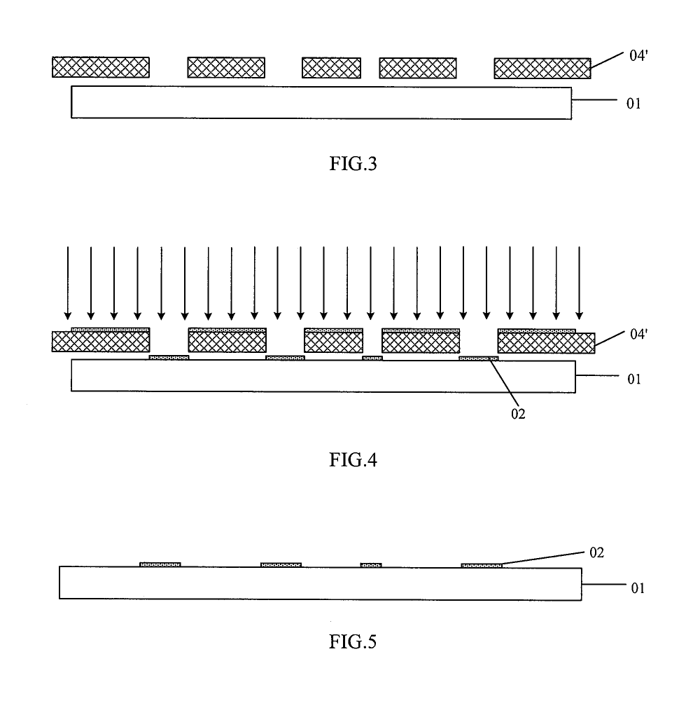

The process of manufacturing the thin film by using the thin film patterning method is shown in FIGS. 3-5. FIG. 3 illustrates the step S1, i.e. is disposing the mask 04′ above the substrate 01. It can be seen from FIG. 3 that the mask 04′ is provided with hollow-out parts which are identical with preset deposition patterns, i.e. hollow-out parts in line with the requirement of the patterning. Therefore, before the thin film is manufactured, the process includes also the steps of manufacturing patterned mask 04′, i.e. coating a hard material on the surface of the base substrate to form a hard material layer, and patterning the base substrate and the hard material layer according to the preset deposition patterns to form the hollow-out parts which are identical with the preset deposition patterns.

FIG. 4 illustrates the step S2, i.e. manufacturing the thin film over the substrate 01 shielded by the mask 04′, specifically comprising: covering the mask 04′ with the thin film, wherein the thin film at the hollow-out parts of the mask 04′ is formed on the substrate 01, while the remaining area of the substrate 01 shielded by the mask 04′ is free of the thin film, so that a patterned thin film is formed on the substrate. The thin film is manufactured by means of a thin film deposition process generally, in which a patterned thin film 02 is formed on the areas of the substrate 01 corresponding to the hollow-out parts of the mask 04′ (the deposition approach is generally adopted in case of a metallic thin film), while at positions shielded by the mask 04′, the thin film material is occluded during the deposition process to lie on the mask 04′ only, and thus cannot cover the substrate 01.

Finally, when the thin film manufacturing is completed, a patterned thin film in line with the requirement of the preset deposition patterns is formed on the substrate 01, as shown in FIG. 5. Therein, the application of the thin film patterning method is not limited to forming a patterned metallic thin film, but a thin film of an organic material and the like can also be formed.

Moreover, due to the fact that the thin film material is deposited on the mask 04′, it is necessary to clear residues on the mask 04′ regularly, or a deviation may be generated between the patterned thin film deposited on the substrate 01 and the preset deposition patterns.

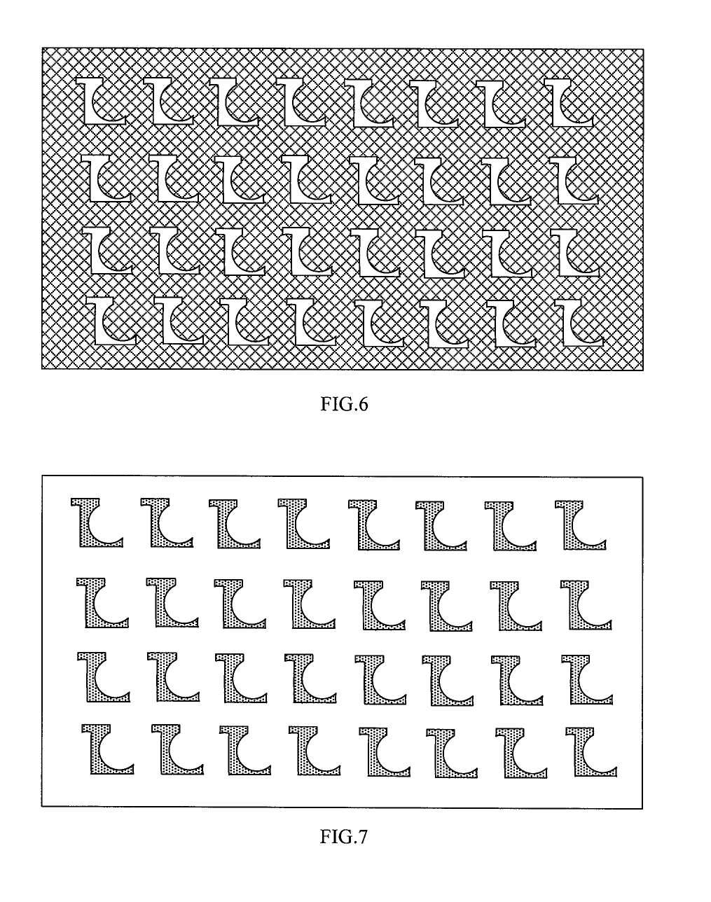

FIG. 6 illustrates a top view of a patterned mask; the mask is used for manufacturing the thin film, with the finally formed patterns of the thin film by deposition on the substrate shown in FIG. 7. It is seen that the obtained thin film patterns on the substrate are consistent with the hollow-out parts of the mask, i.e. direct transferring of the patterns on the mask to the substrate. In this way, the steps of photoresist coating, exposing, developing and etching are omitted on the basis of the existing thin film patterning manufacture, and the step of lifting off the photoresist over the thin film patterns after etching is further omitted. By disposing directly patterned mask above the substrate, thin film patterns as preset can be formed directly on the substrate when the thin film is manufactured, thus the patterns on the mask are transferred directly to the substrate through one-step deposition, and the process steps of photolithography and etching are omitted, the process flow is simplified to a large extent so that the thin film patterning no longer requires such expensive equipments as an exposure machine, an etching machine, etc., and the costs of the thin film patterning is saved.

In addition, a thin film patterning apparatus may comprise a mask and a film coating equipment, wherein the mask is provided with hollow-out parts which are identical with preset deposition patterns, and the film coating equipment forms the patterned thin film directly on the substrate by means of the mask.

The mask may comprise a base substrate and a hard material layer on a surface of the base substrate, wherein the base substrate and the hard material layer are provided with the hollow-out parts which are identical with the preset deposition patterns.

The base substrate may be of a stainless steel material. The mask in the stainless steel material has the characteristics of high precision, smooth surface, invulnerability to bending and deformation, and durability in use, and is meanwhile ensured for tight fitting with devices to reduce the shadow effects and thus it is more controllable in disturbance. Moreover, the mask in the stainless steel material further requires a considerably low coefficient of expansion so as to ensure that the dimensions of the mask and of the patterns on the mask could not be influenced by any temperature rise during the process of utilizing the mask for manufacture, or that such influence could be as reduced as possible.

The hard material layer may be made of any material of chromium, chromium oxide and iron oxide.

The above-described thin film patterning apparatus has the same technical effects as the above-described thin film patterning method, which will not be repeated here.

The above-mentioned embodiments are only for illustrating and not restricting the present invention. It is to be noted that various modifications and variations can be made by one of ordinary skill in the art without departing from the spirit and scope of the present invention, and therefore, all equivalent technical schemes belong to the scope of the present invention as well, while the protection scope of the present invention should be defined by the claims.

1. A thin film patterning method, comprising:
disposing a mask above a substrate, wherein the mask is provided with hollow-out parts which are identical with preset deposition patterns; and
covering the mask with a thin film, wherein the thin film at the hollow-out parts of the mask is formed on the substrate, while the remaining area of the substrate shielded by the mask is free of the thin film, so that a patterned thin film is formed on the substrate.

2. The thin film patterning method according to claim 1, wherein a method for manufacturing the mask comprises:
coating a hard material on a surface of a base substrate to form a hard material layer, and patterning the base substrate and the hard material layer according to the preset deposition patterns to form the hollow-out parts which are identical with the preset deposition patterns.

3. The thin film patterning method according to claim 2, wherein the base substrate is of a stainless steel material.

4. The thin film patterning method according to claim 3, wherein the stainless steel material is an SUS304 H stainless steel.

5. The thin film patterning method according to claim 3, wherein a thickness of the base substrate is 0.03 mm, 0.05 mm, 0.06 mm, 0.08 mm or 1 mm.

6. The thin film patterning method according to claim 2, wherein the hard material is any of chromium, chromium oxide and iron oxide.

7. The thin film patterning method according to claim 1, wherein the thin film is of a metal material or an organic material.

8. The thin film patterning method according to claim 1, wherein the covering the mask with a thin film is by means of a thin film deposition process.

9. A thin film patterning apparatus, comprising a mask and a film coating equipment, wherein the mask is provided with hollow-out parts which are identical with preset deposition patterns, and the film coating equipment forms a patterned thin film directly on a substrate by means of the mask.

10. The thin film patterning apparatus according to claim 9, wherein the mask comprises a base substrate and a hard material layer on a surface of the base substrate, wherein the base substrate and the hard material layer are provided with the hollow-out parts which are identical with the preset deposition patterns.

11. The thin film patterning apparatus according to claim 10, wherein the base substrate is of a stainless steel material.

12. The thin film patterning apparatus according to claim 11, wherein the stainless steel material is an SUS304 H stainless steel.

13. The thin film patterning apparatus according to claim 11, wherein a thickness of the base substrate is 0.03 mm, 0.05 mm, 0.06 mm, 0.08 mm or 1 mm.

14. The thin film patterning apparatus according to claim 10, wherein the hard material layer is made of any material of chromium, chromium oxide and iron oxide.

15. The thin film patterning apparatus according to claim 9, wherein the thin film is of a metal material or an organic material.

16. The thin film patterning apparatus according to claim 9, wherein the covering the mask with a thin film is by means of a thin film deposition process.
